(19) United States
(12) Patent Application Publication
(10) Pub. No.: US 2018/0036950 A1
(43) Pub. Date: Feb. 8, 2018

(54) DETERMINING A PARAMETER OF A PROCESS ASSOCIATED WITH A 3D PRINTING PROCESS

(71) Applicants: Xavier VILAJOSANA, Sant Cugat del Valles (ES); Pol FORNOS, Sant Cugat del Valles (ES); Sergio PUIGARDEU ARAMENDIA, Sant Cugat del Valles (ES); David RAMIREZ MUELA, Sant Cugat del Valles (ES); HEWLETT-PACKARD DEVELOPMENT COMPANY, L.P., Houston, TX (US)

(72) Inventors: Xavier Vilajosana, Sant Cugat del Valles (ES); Pol Fornos, Barcelona (ES); Sergio Puigardeu Aramendia, Barcelona (ES); David Ramirez Muela, Sant Cugat del Valles (ES)

(73) Assignee: HEWLETT-PACKARD DEVELOPMENT COMPANY, L.P., Houston, TX (US)

(21) Appl. No.: 15/542,611

(22) PCT Filed: Apr. 14, 2015
(86) PCT No.: PCT/EP2015/058061

§ 371 Date: Jul. 10, 2017

(51) Int. Cl. B29C 64/393; B33Y 50/02; B33Y 10/00; B33Y 30/00; B29C 64/153; B29C 64/357

(52) U.S. Cl. CPC B29C 64/393; B29C 64/153; B29C 64/357; B33Y 10/00; B33Y 30/00; B33Y 50/02

(57) ABSTRACT

A method for determining a parameter of a process associated with a 3D printing process provided. A first amount corresponding to an object of fused powder surrounded by non-fused powder is used. The first amount is separated into a second amount of non-fused powder and a third amount corresponding to the object including residual powder material attached. The residual powder material is removed from the object using a fourth amount of a cleaning agent. A fifth amount corresponding to the fused powder of the cleaned object and a sixth amount of material corresponding to a mixture of the removed residual powder material and the cleaning agent is obtained. The mixture includes a seventh amount of material being recovered, an eighth amount of material corresponding to powder material wastage, and the fourth amount. The parameter is derived from at least two of first to eighth amounts of material.

### BACKGROUND

In three-dimensional printing processes, three-dimensional (3D) objects can be built by fusing powder material. The powder material can be fused, for example, by using a fusing agent which evaporates during the printing process. When the printing process is finished, a container may contain the object of fused powder which is surrounded by non-fused powder.

After the printing process the container can be transferred to a cleaning and powder recycling station which may perform a cleaning process to separate and clean the three-dimensional object from the surrounding powder. A certain amount of the separated powder material can be recovered for a following 3D printing process.

### BRIEF DESCRIPTION OF THE DRAWINGS

FIG. 1 illustrates a container containing an object of fused powder surrounded by non-fused powder which may be the result of a 3D printing process, according to one example.

FIG. 2 illustrates the content of the container of FIG. 1 which may be used in an aspect of the present disclosure, according to one example.

FIGS. 3 to 7 illustrate subsequent states of a cleaning and recovery process associated with a 3D printing process according to some examples.

FIG. 8 illustrates a flow diagram of a process according to an example.

FIG. 9 illustrates an example of a system according an aspect of the present disclosure.

### DETAILED DESCRIPTION

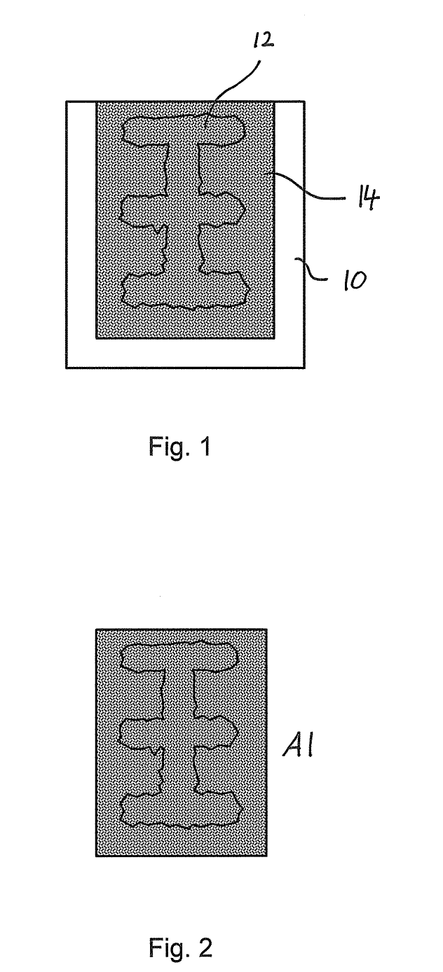

Referring to FIG. 1, a container 10, such as a bucket, is output from a three-dimensional (3D) printing process. The container 10 contains a 3D object 12 of fused powder which is surrounded by non-fused powder 14. The content of the container 10 is illustrated in FIG. 2 and corresponds to a first amount A1.

In the present disclosure, an “amount” may correspond to the weight of a material or a mixture of materials or the weight of an object which is built of a material. Further, an “amount” may also correspond to the volume of a material or a mixture of materials or the volume of an object which is built of a material. Accordingly, an amount corresponds to a quantity which may be defined in terms of weight and/or volume. If the density is known, the weight can be obtained from the volume and vice versa.

The first amount A1 corresponding to the content of the container 10 can be obtained, for example, by weighing the filled container of FIG. 1 and subtracting the weight of the container 10 from the weighing result. The weight of the container may be known or obtained by weighing when the container 10 is empty. Alternatively, the amount A1 may be obtained from the volume of the container 10 which may be known or measured. In another example, the first amount may be obtained from a memory in which an amount value is stored, such as a weight value. Such a value may be computed during a preceding 3D printing process, when the container is filled with powder. This can be done for example by using an internal scale or any other weight measurement system, such as gauges, which may be integrated into the container.

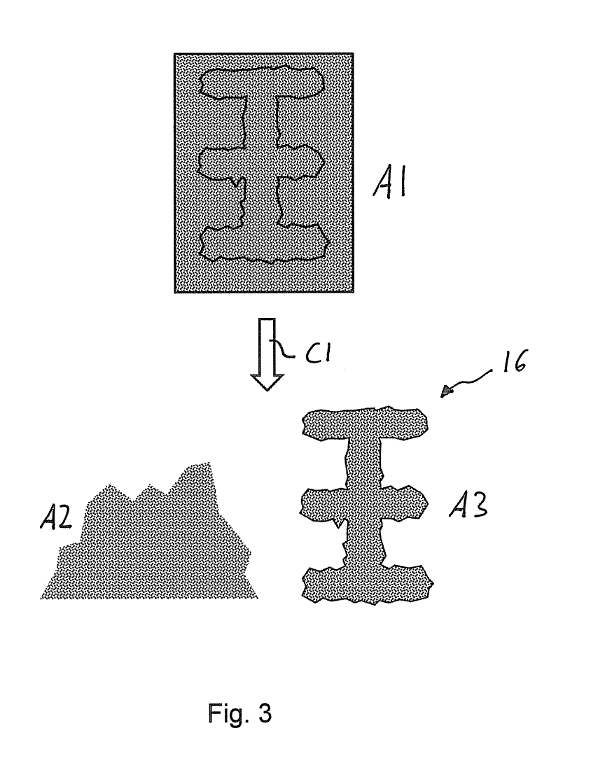

Referring to FIG. 3, a cleaning process C1 is illustrated which may be used according to an aspect of the present disclosure. Examples of cleaning processes use vibration, air pressure, movement, or a combination thereof. As illustrated in FIG. 3, the first amount A1 can be separated into a second amount A2 of non-fused powder and the object 16. After the cleaning process C1 of FIG. 3, the object 16 may have residual powder material attached. The object 16 having residual powder material attached corresponds to a third amount A3 of material. The amounts A1 to A3 are related as follows:

A1=A2+A3 (I)

After separating the amount of non-fused powder corresponding to the second amount A2 and the object 16 having residual powder material corresponding to the third amount A3 during the cleaning process C1, the non-fused powder corresponding to the second amount A2 can be recovered. The recovered powder of the second amount A2 may be recycled, i.e. it may be used in a following 3D printing process for printing another 3D object.

The second amount A2 may be derived, for example, by directly weighing the amount of separated non-fused powder, which is shown at the bottom left in FIG. 3. Alternatively, the second amount A2 may be indirectly obtained by weighing the object 16 having residual powder material attached thereto and by subtracting the weighing result from the weight corresponding to the first amount A1. That is, A2 may be obtained from A1 and A3 based on the above relationship (I), i.e. as:

A2=A1−A3 (I′)

The third amount A3 may be obtained in a similar way to the second amount A2, namely by directly weighing the object 16 having residual powder material attached or by weighing the amount A2 and subtracting the weighing result from the amount A1, for example. That is, A3 may be obtained from A1 and A2 based on relationship (I) as:

A3=A1−A2 (I″)

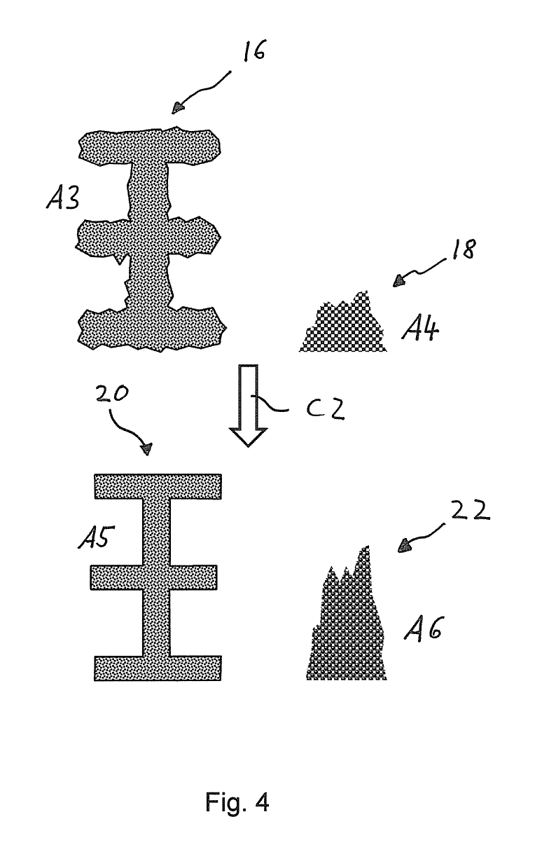

Referring to FIG. 4, a further cleaning process C2 is illustrated which may be used according to an aspect of the present disclosure. In the next cleaning process C2, the object 16 having residual powder material attached can be cleaned from the residual powder material by using an amount of a cleaning agent 18 corresponding to a fourth amount A4. The next cleaning process C2 may result in a cleaned object 20 corresponding to a fifth amount A5 of material and a mixture 22 corresponding to a sixth amount A6 of material. The mixture 22 may comprise or may be composed of the residual powder material which has been removed from the object 16 during the next cleaning process C2 and the amount of cleaning agent A4 utilized in the next cleaning process C2. Accordingly, the amounts A3 to A6 may be related by the following relationship (II):

A3+A4=A5+A6 (II)

The next cleaning process C2 may be more intense than the cleaning process C1, such that material may be removed from the object which could not be removed by the previous cleaning process C1. For example, a stronger cleaning force may be applied to the object. The next cleaning process C2 may comprise the use of air pressure, movement, vibration, a blasting process or a combination thereof. The cleaning agent may be sand, a liquid, another abrasive or non-abrasive cleaning agent, or a combination thereof. For example, the next cleaning process C2 may comprise a blasting process which uses an abrasive cleaning agent, such as a sandblasting process which uses sand. In some examples, the amount of cleaning agent corresponding to the fourth amount A4 is obtained by weighing or measuring the amount of cleaning agent 18 which is used in the next cleaning process C2 before the corresponding cleaning process takes place. In other examples, the fourth amount A4 is obtained based on the cleaning time t and on the amount Aₜ of cleaning agent 18 which is used per time, i.e. by A4=t·Aₜ.

The amount of the mixture 22 corresponding to the sixth amount A6 may correspond to the sum of the residual powder material which was attached to the cleaned object 20 and which has been removed from the cleaned object 20 and the amount of cleaning agent 18 used. That is, in an ideal case, when no material is lost, the amount of the mixture 22 corresponding to the sixth amount A6 can be determined based on the amounts A3, A4 and A5 and on the above relationship (II):

A6=A3−A5+A4 (II′)

However, even in non-ideal cases, e.g. when a certain portion of material is lost and not considered, the above relationships (I) and (II) may allow for a sufficiently precise estimation of an amount or of a process parameter. The reason is, that for the processes referred to herein, the above relationships (I) and (II) may consider the flow of the major portion of material such that the unconsidered material loss may be comparatively small.

The amounts A5 and A6 may be directly obtained by weighing. Alternatively, at least one of the amounts A1 to A6 can be obtained based on other amounts of A1 to A6 by using at least one of the above relationships (I) and (II).

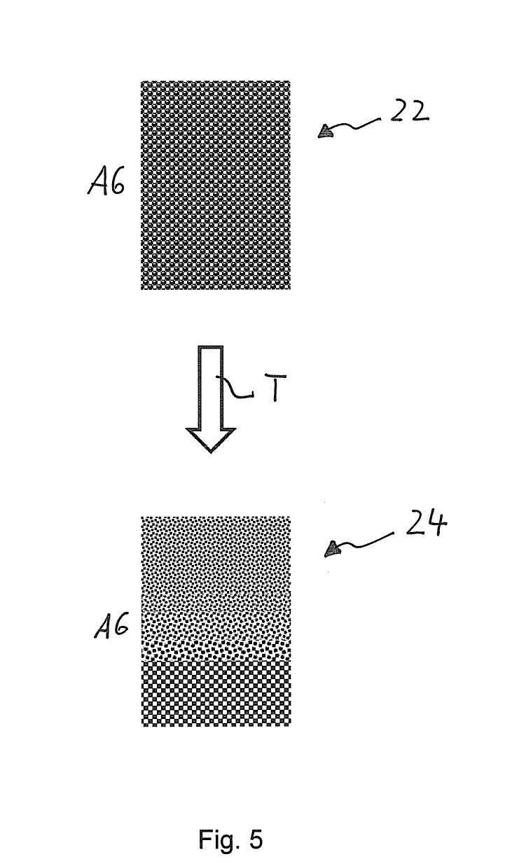

Referring to FIG. 5, a treatment process T is illustrated which can be used for treating the mixture 22 according to an aspect of the present disclosure. At the top, FIG. 5 illustrates the mixture 22 corresponding to the sixth amount A6 which can be contained in a recovery container (not shown). In some examples, the treatment is performed by using vibration which may cause a sedimentation within the mixture, such that a treated mixture 24 is provided. The treated mixture 24 is shown at the bottom of FIG. 5. Due to the treatment T the powder material and cleaning agent 18 can be spatially separated in the treated mixture 24.

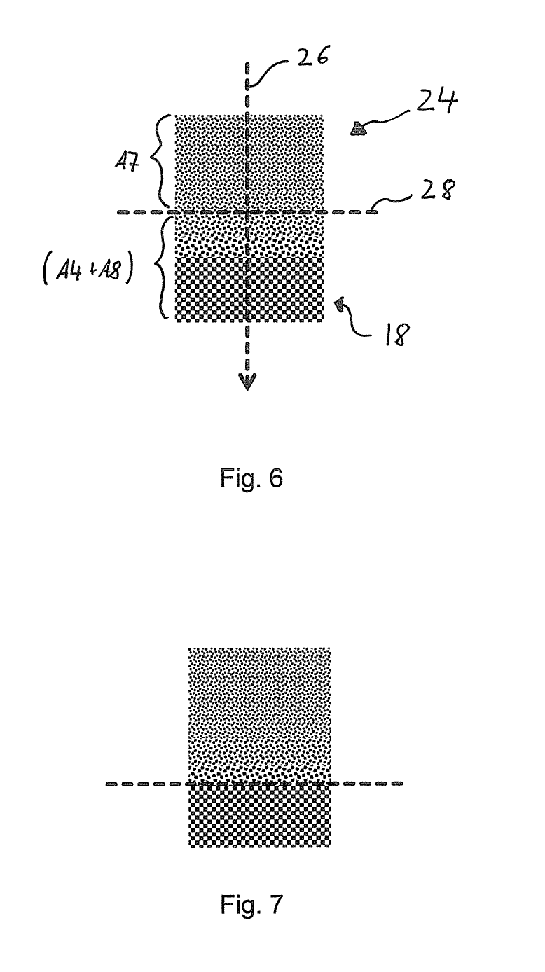

FIG. 6 shows the treated mixture 24 of FIG. 5 in which powder material and cleaning agent 18 are spatially separated along a separation direction 26. In the example described, the separation direction is vertical because separation is performed under the influence of gravity. When compared to the untreated mixture 22 (FIG. 5, top), the bulk of the cleaning agent 18 will move downwards in the separation direction 26. The separation direction or movement direction of the cleaning agent 18 is indicated by the arrow 26 in FIG. 6. The powder material within the mixture will move upwards, opposite to the separation direction 26, wherein in the example of FIG. 6, smaller powder particles will assemble in the upper region (i.e. “above” in the mixture 24 of FIG. 6) and wherein the powder particle size increases downwards or in the separation direction (indicated by the direction of the arrow 26, which points downwards).

FIG. 6 further shows a horizontal plane 28 at a predefined height along the separation direction 26 in the recovery container (not shown). The height, and thus the plane 28, corresponds to a minimum quality threshold. In the example of FIG. 6, the material of the treated mixture 24 which is above the plane 28, can be recovered for a following 3D printing process and corresponds to a seventh amount A7 of recovered material.

The amount A7 may be determined, for example, by weighing the material which is recovered, after it has been removed from the treated mixture 24. In other examples, the seventh amount A7 corresponding to the material which may be recovered can be determined based on the height of the plane 28 along the separation direction 26. If the treated mixture 24 is confined in a defined and known volume of a particular shape, e.g. in a known recovery container, the volume and hence the amount A7 can be readily obtained from the height of the horizontal plane 28. For example, if the treated mixture 24 is confined in a cylindrical container and the plane 28 has a height, such that the plane 28 is located in the middle of the container, then the seventh amount A7 corresponds to half of the volume of the cylindrical container.

Likewise to the seventh amount A7 also the sixth amount A6 corresponding to the amount of the mixture may be determined based on a height, namely based on the height of the material of the mixture in the container. This height of the material in the container may be determined by a mechanical sensor using a moving part that changes its position according to the height of the material, such as a buoy. In other examples, an IR sensor is used to determine the height of the material in the container. For determining the height of the material in the container at least one of a mechanical sensor, such as a pressure sensor or a capacitive sensor, and an inductive sensor can be used. The sensor may be disposed on the side of the container.

The powder material, which in the example of FIG. 6 is below the plane 28, is not recovered and corresponds to wastage which will be lost. The amount of powder material wastage corresponds to an eighth amount A8 of material. Depending on the degree of separation which in turn may depend on the specific treatment process and the treatment time, the amount A7 above plane 28 in FIG. 6, in an ideal case, may be completely free of cleaning agent 18. In other examples, the amount A7 may comprise residual cleaning agent 18 to some specified extent. Because, after the treatment, the extent of cleaning agent in A7 may be comparatively small and because the amount of unconsidered material loss may be relatively small, the amount of material of the mixture 24 below the plane 28 in FIG. 6 may correspond to the sum of the amount of used cleaning agent 18, namely A4, and the amount of residual powder material which is not recovered corresponding to wastage, namely A8, as a sufficiently precise estimation, i.e. may correspond to A4+A8. Therefore, the amount A8 corresponding to wastage can be derived, for example, from the fourth amount A4 of cleaning agent 18 and the seventh amount A7 of material recovered from the mixture 24 based on the following relationship (III):

A8=A6−A7−A4 (III)

In another example, the eighth amount A8 corresponding the powder material wastage may be directly determined by weighing the remaining amount of the treated mixture 24 after the amount of powder material which can be recovered, namely A7, and the amount of used cleaning agent, namely A4, have been removed. If no material is lost in previous process stages or during powder recovery and if the remaining amount of the treated mixture 24 does not comprise any cleaning agent 18, the weighed eighth amount A8 corresponds exactly to the wastage of powder material. In some examples, a certain amount of material which is not taken into account for the determination of A8 may be lost in a previous or later process stage. Further, the remaining amount of the treated mixture 24 still may comprise a certain amount of cleaning agent. However, even in these examples the determination of the powder material wastage may be sufficiently precise, if the other losses or the amount of cleaning agent in the remaining amount of the treated mixture 24 are small compared to the other absolute amounts.

Based on at least two of the amounts A1 to A8, different process parameters of the 3D printing process and subsequent cleaning and recovery processes can be determined. For example, the process parameter of the powder wastage, namely A8, resulting for the combined processes of 3D printing, separating the object from the surrounding non-fused powder material, cleaning the object and recovering of powder material can be estimated based on the above relationship (III) using the amounts A6, A7 and A4. This estimation of the powder wastage, namely A8, based the amounts A6, A7 and A4, may correspond to an exact determination, if no powder material is lost except for the not recovered powder of the mixture and if the recovered amount above the plane 28, namely A7, is free of cleaning agent. If not more than a comparatively small amount of powder is lost, besides the not recovered powder wastage in the mixture or, if the powder which is recovered from the mixture, namely A7, comprises not more than a small amount of cleaning agent, the determination of A8 may be a precise estimation of the powder material wastage.

Based on at least two of the amounts A1 to A8, different process parameters of the 3D printing process and subsequent cleaning and recovery processes can be determined. For example, the process parameter of the powder consumption of the combined processes of 3D printing, separating the object from the surrounding non-fused powder material, cleaning the object and recovering of powder material can be determined. The powder consumption corresponds to the sum of the amount of fused powder of the cleaned object 20, namely A5, and the amount of powder material wastage, namely A8. Accordingly, the powder consumption may be determined based on A5 and A8. In one example, A5 and A8 are directly obtained, e.g. by weighing, and the powder consumption PC is derived by determining the sum of A5 and A8, i.e. by PC=A5+A8. In other examples the powder consumption can be determined based on other amounts A1 and A8, e.g. by using at least one of the following relationships:

A1=A2+A3 (I)

A3+A4=A5+A6 (II)

A6=A4+A7+A8 (III)

A3−A5=A7+A8 (IV)

A1−A2+A4=A5+A6 (V)

The relationships (I), (II) and (III) can be derived from the illustrations of FIGS. 3, 4 and 6, respectively, and have been explained above. Relationship (IV) can be obtained by combining relationships (II) and (III). Relationship (V) can be obtained by combining relationships (I) and (II).

By combining relationship (II) and PC=A5+A8, the powder consumption PC can be determined based on a group of the amounts A3, A4, A6 and A8, namely as

PC=A3+A4−A6+A8.

By combining relationship (III) and PC=A5+A8, the powder consumption PC can be determined based on a group of the amounts A4, A5, A6 and A7, namely as

PC=A5+A6−A7−A4.

By combining relationship (IV) and PC=A5+A8, the powder consumption PC can be determined based on a group of the amounts A3 and A7, namely as

PC=A3−A7.

By combining relationship (V) and PC=A5+A8, the powder consumption PC can be determined based on a group of the amounts A1, A2, A4, A6 and A8, namely as

PC=A1−A2+A4−A6+A8.

Based on at least two of the amounts A1 to A8 which may be determined as previously explained, also other process parameters may be derived, such as the amount of utilized clean ing agent (e.g. as A4=A5+A6−A3), the amount of recovered powder RP (e.g. as RP=A2+A7), the weight of the cleaned object (e.g. as A5=A3+A4−A6), the amount of residual attached powder material AP (e.g. as AP=A3−A5). All of these parameters may be provided to a user for process control and monitoring purposes or for the purpose of optimization, wherein said optimization may be based on the knowledge of at least one actual parameter value and/or its development over time.

By shifting or adjusting the height of plane 28 upwards or downwards along the separation direction in FIG. 6, the quality of the powder recovered from the mixture corresponding to the seventh amount A7 can be changed and adjusted to a desired recovery quality. If, for example, the height of plane 28 is shifted upwards in FIG. 6, the particle size in the recovered powder material of the seventh amount A7 is reduced on average which may correspond to a better material quality. On the other hand, if the height of plane 28 is shifted downwards, the average particle size in the recovered powder material A7 increases, such that the material quality may be impaired. In this way, a minimum quality threshold can be adjusted according to the specific needs of the 3D printing process and/or the object. For example, if the printed 3D object comprises thin and delicate structures which are manufactured using a high quality powder material for the 3D printing process, the plane 28 may be set or adjusted to a corresponding larger height along the separation direction 26, such that the recovered powder material provides the desired material quality and the specific structures can be achieved in the desired quality.

The improvement of the material quality of the amount A7 of powder recovered from the mixture may reduce the amount of recovered material A7 and may increase the amount of powder wastage A8 and vice versa. For example, if the object has rather rough structures which tolerate a lower quality of powder material, then for optimizing the process in terms of material exploitation, the minimum quality threshold may be reduced to achieve a minimum amount of powder wastage A8, which still is sufficient to provide a specific quality of the object, such that the powder consumption may be minimized for saving costs.

Referring to FIG. 7, an additional horizontal plane 30 of the treated mixture 20 is illustrated which can be used for determining and separating the amount A4 of used cleaning agent 18 which has moved downward in the separation direction during the treatment and which has accumulated in a region below the plane 30.

There are other examples for obtaining the amount A4 of cleaning agent 18. For example, the amount A4 may be obtained by using the height of the plane 30 along the separation direction in a recovery container (not shown) to determine the volume of the accumulated cleaning agent 18 below plane 30, similar as explained above for the amount A7 with respect to the plane 28. According to another example, the amount A4 of material below plane 30 is removed and obtained by weighing.

In some examples, the separation after the treatment process T may not be perfectly complete, such that the material below plane 30 might not correspond to 100% of the cleaning agent 18 and the material above plane 30 might not be completely free of cleaning agent 18. In such examples, the obtained amount A4 may correspond to a sufficiently precise estimation of the amount of utilized cleaning agent 18, if the separation is sufficient and if no cleaning agent or a comparatively small amount of cleaning agent is lost outside the mixture. In the present disclosure the accuracy of an estimation may depend on the degree of separation after the treatment process, on the existence of unaccounted material losses and on the relative extent of the unaccounted material losses. Because the material losses or other constituents which are not considered by the above relationships may be relatively small, the separation can be adjusted to a degree which allows for an estimation which is sufficiently precise. For example, small portions of powder or cleaning agent may be lost when transferring the substances from one container to another. These may be neglected. As another example, the powder material can be fused by using a fusing agent which evaporates fully or to a large extend during the printing process. Any remaining parts of the fusing agent within the fused object or powder may be so small that they can be neglected and still obtain a precise estimation.

Some or all of the above process parameters may be monitored and used for adjusting the minimum quality threshold in order to obtain a corresponding process profile, wherein different process profiles may fulfill different needs in terms of quality of the powder material, such as a specific particle size, and/or in terms of consumption/wastage of powder material.

In some examples, the plane 28 corresponding to the minimum quality threshold in FIG. 6 can be adjusted or positioned along the separation direction 26 based on a material property within the treated mixture 24. For example, the plane 28 can be at a height where the material of the treated mixture 27 has a particle size in the range between 20 μm and 80 μm, for example an average particle size of about 50 μm.

In some examples the cleaning process C2 comprises sandblasting and the cleaning agent 18 comprises sand with a particle size of about 100 μm or more. In some of the examples, the minimum quality threshold corresponds to a powder particle size of about 50 μm. Additionally or alternatively, the cleaning agent 18 may also comprise a liquid.

The material property within the treated mixture 24, based on which the height of the plane 28 corresponding to the minimum quality threshold can be adjusted, can be measured. The measurement of the material property can be performed, for example, with a particle size sensor, a liquid-powder range sensor or a liquid-powder distance sensor, or by a combination of them.

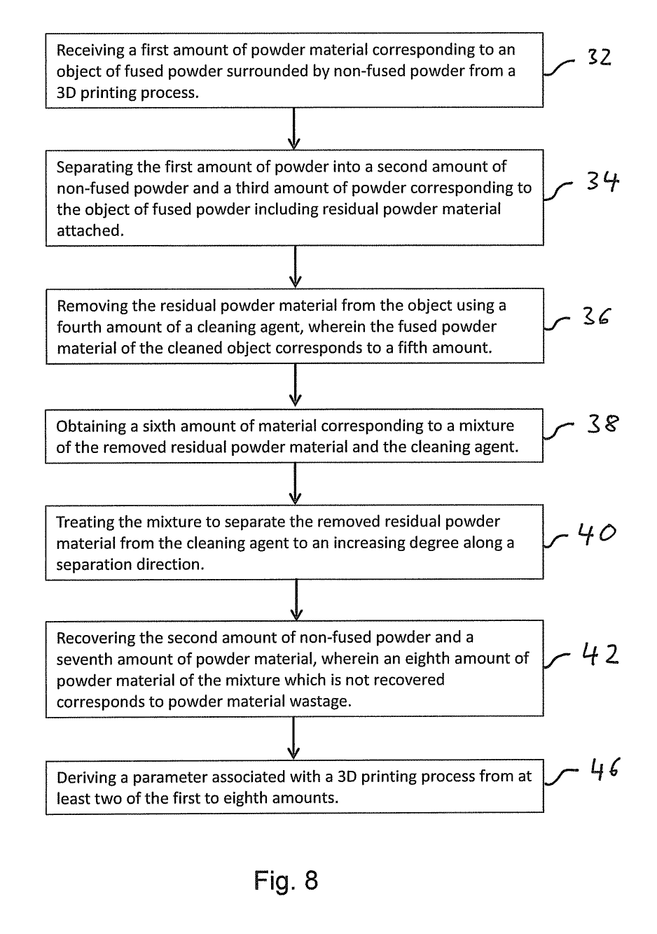

Referring to FIG. 8, an example of a process for determining a parameter is illustrated. In a process stage 32, a first amount A1 of powder material corresponding to an object 12 of fused powder surrounded by non-fused powder 14 can be received from a 3D printing process. In a later stage 34, the first amount A1 of powder can be separated into a second amount A2 of non-fused powder and a third amount A3 of powder corresponding to the object 16 of fused powder including residual powder material attached. Then, in a next stage 36, the residual powder material may be removed from the object 16 using a fourth amount A4 of a cleaning agent 18. The fused powder material of the cleaned object 20 corresponds to a fifth amount A5. In a further stage 38, a sixth amount A6 of material corresponding to a mixture 22 of the removed residual powder material and the cleaning agent 18 can be obtained. In a subsequent stage 40, the mixture 22 can be treated to separate the removed residual powder material from the cleaning agent 18 to an increasing degree along a separation direction 26. Then, as shown in stage 42 of FIG. 8, the second amount A2 of non-fused powder 14 and a seventh amount A7 of powder material can be recovered from the process, wherein an eighth amount A8 of powder material of the mixture 24, which is not recovered, corresponds to powder material wastage. In a next stage 44, a parameter associated with a 3D printing process can be derived from at least two of the first to eighth amounts A1 to A8.

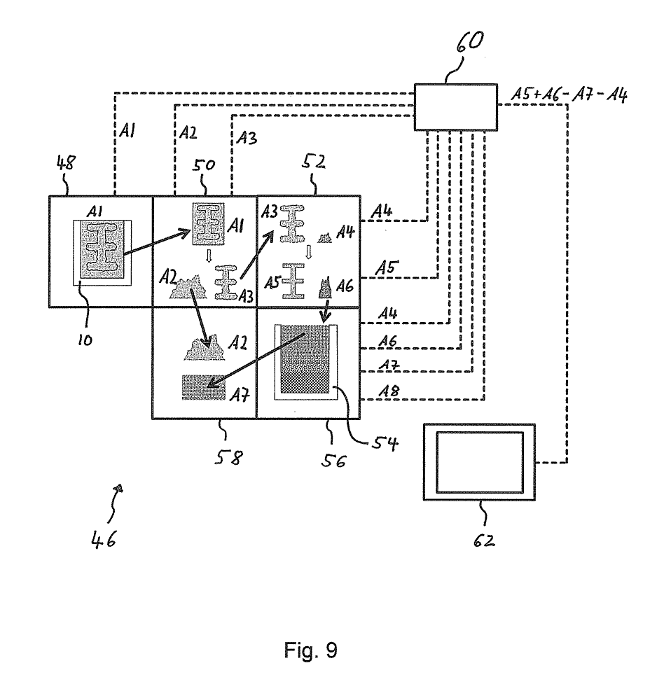

Referring to FIG. 9, an example of a system 46 is shown which is configured for cleaning an object 12 of fused powder, for recovering powder material, for determining a parameter of a process associated with a 3D printing process and for displaying the parameter to a user. The system 46 which is shown in FIG. 9 comprises a receiving unit 48, a separation unit 50, a cleaning unit 52, a recovery container 54, a treatment unit 56, a recovery unit 58, a processor 60 and a display element 62.

As shown in the example of FIG. 9, the receiving unit 48 may receive a container 10 containing an object 12 of fused powder surrounded by non-fused powder 14 from a 3D printing process. As indicated by an arrow in FIG. 9, the content of the container 10, which corresponds to a first amount A1, may be transferred to the separation unit 50. In the separation unit 50 the first amount A1 may be separated into a second amount A2 of non-fused powder and a third amount A3 corresponding to the object 16 having residual powder material attached. As shown in FIG. 9, the second amount A2 of non-fused powder 14 may be transferred to the recovery unit 58 and the object 16 having residual powder material attached may be transferred to the cleaning unit 52.

In the cleaning unit 52, the object 16 having residual powder material attached may be cleaned from the residual powder material by using a fourth amount A4 of a cleaning agent 18, such that a fifth amount A5 corresponding to fused powder material of the cleaned object 20 and a sixth amount A6 corresponding to a mixture 22 of the cleaning agent 18 and the residual powder material may be obtained.

The mixture 22 may be transferred to the treatment unit 56. In the treatment unit 56, the mixture 22 may be treated, within the recovery container 54, to separate the residual powder material from the cleaning agent 18 to an increasing degree along a separation direction 26, wherein the particle size of the residual powder material may decrease with increasing distance from the cleaning agent 18.

After the treatment process, a seventh amount A7 of powder material may be removed from the treated mixture 24 and transferred to the recovery unit 58, as illustrated in FIG. 9. The amounts which are transferred to the recovery unit 58, namely the second amount A2 of non-fused powder and the seventh amount A7 of powder material from the treated mixture 24, can be used for a following 3D printing process. The remaining amount of residual powder material within the mixture which is not recovered corresponds to an eighth amount A8 corresponding to powder material wastage.

In the example of FIG. 9, five different units 48, 50, 52, 56, 58 are provided for different process stages corresponding to receiving, separating, cleaning, treating and recovering of powder material, respectively. In other examples, different process stages can be performed within the same unit. For example, the process of separating which is performed in the separation unit 50 of FIG. 9 and the process of cleaning which is performed in the cleaning unit 52 of FIG. 9 can be performed in a single unit, which then includes both a separation unit and a cleaning unit.

In the system 46, different amounts can be determined in the different units, for example by weighing. In the example of FIG. 9, the first amount A1 is determined by the receiving unit 48, the second and third amounts A2, A3 are determined by the separation unit 50, the fourth and fifth amounts A4, A5 are determined by the cleaning unit 52 and the fourth, sixth, seventh and eighth amounts A4, A6, A7, A8 are determined by the treatment unit 56. In other examples, some or all of the amounts may be determined by different units.

As illustrated in FIG. 9, the amounts A1 to A8 may be communicated to the processor 60. The processor 60 may derive a process parameter based on at least two of the amounts A1 to A8. For example, the processor 60 may derive a powder material consumption PC of the process comprising 3D printing, separating, cleaning and recovering of powder, wherein the powder material consumption PC may be determined based on one of the following relations: PC=A5+A6−A7−A4, PC=A3+A4−A6+A8, PC=A1−A2+A4−A6+A8 and PC=A3−A7. The parameter, such as the powder material consumption, may be transmitted to a display element 62 for displaying the parameter to a user, and further may be fed back to the 3D printing process for adjusting the process.

1. A method for determining a parameter of a process associated with a 3D printing process, the process comprising:
using a first amount of powder material corresponding to an object of fused powder surrounded by non-fused powder,
separating the first amount of powder into a second amount of non-fused powder which is recovered from the process and a third amount of powder corresponding to the object of fused powder including residual powder material attached,
removing the residual powder material from the object using a fourth amount of a cleaning agent, and obtaining a fifth amount of material corresponding to the fused powder of the cleaned object and a sixth amount of material corresponding to a mix-tune of the removed residual powder material and the cleaning agent, the mixture including a seventh amount of material which is recovered from the mixture, an eighth amount of material which corresponds to powder material wastage, and the fourth amount of the cleaning agent,
wherein the parameter of the process associated with the 3D printing process is derived from at least two of the first to eighth amounts.

2. The method of claim 1, wherein at least one of the first to eighth amounts is obtained by weighing.

3. The method of claim 1, wherein the parameter corresponds to a powder material consumption which is derived based on one of the following groups of amounts: fifth and eighth amounts; third, fourth, sixth and eighth amounts; fourth, fifth, sixth and seventh amounts; third and seventh amounts; first, second, fourth, sixth and eighth amounts.

4. The method of claim 1, wherein the at least one of separating the first amount of powder and removing the residual powder is performed by using air pressure, movement, vibration, or a combination thereof.

5. The method of claim 1, wherein the cleaning agent comprises sand, another abrasive agent, a non-abrasive agent, or a combination thereof.

6. The method of claim 1, wherein the parameter corresponds to an amount of consumed powder, an amount of powder wastage or an amount of recovered powder.

7. The method of claim 1, wherein the second amount and the seventh amount are recovered and are used for a following 3D printing process.

8. The method of claim 1, wherein the parameter is displayed to a user.

9. The method of claim 1, wherein the mixture of removed residual powder material and cleaning agent is treated in a recovery container to separate the removed residual powder material from the cleaning agent to an increasing degree along a separation direction which extends vertically through the recovery container, wherein a particle size of the removed residual powder material decreases with increasing distance from the cleaning agent along the separation direction.

10. The method of claim 9, wherein the cleaning agent and the removed residual powder material are separated by using at least one of vibration and sedimentation.

11. The method of claim 9, wherein the seventh amount is determined based on a minimum quality threshold corresponding to a horizontal plane in the recovery container at a predefined height along the separation direction, wherein the seventh amount is removed from the mixture.

12. The method of claim 11, wherein the minimum quality threshold corresponds to a particle size of the powder contained in the mixture and the minimum quality threshold is adjusted to a particle size between 20 μm and 80 μm, or of about 50 μm.

13. The method of claim 9, further comprising measuring, at a predetermined height position along the separation direction in the recovery container, at least one of the following material properties of the mixture: particle size, powder particle density, liquid-powder range.

14. A device for use in a system, wherein the system includes
a container, receiving a first amount of powder material corresponding to an object of fused powder surrounded by non-fused powder from a 3D printing process,
a separation stage, separating the first amount of powder into a second amount of non-fused powder which is to be recovered and a third amount of powder corresponding to the object of fused powder including residual powder material attached,
a cleaning stage, removing the residual powder material from the object using a fourth amount of a cleaning agent, wherein a fifth amount of material corresponds to the fused powder of the cleaned object and a sixth amount of material corresponds to a mixture of the removed residual powder material and the cleaning agent, the mixture including a seventh amount of material which is to be recovered from the mixture, an eighth amount of material which corresponds to powder material wastage, and the fourth amount of the cleaning agent,
wherein the device further includes a processor obtaining two or more of the first to eighth amounts and deriving a process parameter of a process associated with a 3D printing process from at least two of the first to eighth amounts.

15. A system, comprising
a receiving unit for receiving, from a 3D printing process, a first amount of powder material corresponding to an object of fused powder surrounded by non-fused powder,
a separation unit for separating the first amount of powder into a second amount of non-fused powder and a third amount of powder corresponding to the object of fused powder including residual powder material attached,
a cleaning unit for removing the residual powder material from the object using a fourth amount of a cleaning agent, wherein a fifth amount of material corresponds to the fused powder of the cleaned object and a sixth amount of material corresponds to a mixture of the removed residual powder material and the cleaning agent,
a recovery container for collecting the mixture, which includes a seventh amount of material which is recovered from the mixture, an eighth amount of material which corresponds to powder material wastage, and the fourth amount of the cleaning agent,
a treatment unit for applying vibration to the mixture contained in the recovery container,
a recovery unit for recovering the second amount and the seventh amount of material from the 3D printing process,
a processor for obtaining two or more of the first to eighth amounts and for deriving a powder material consumption based on one of the following groups of amounts: fifth and eighth amounts; third, fourth, sixth and eighth amounts; fourth, fifth, sixth and seventh amounts; third and seventh amounts; first, second, fourth, sixth and eighth amounts, and
a display element for displaying the powder material consumption to a user.
